(19) United States
(12) Patent Application Publication
(10) Pub. No.: US 2014/0058874 A1
(43) Pub. Date: Feb. 27, 2014

(54) INTEGRATION OF COMMERCE NETWORKS

(71) Applicants: Yuan Tung, Fremont, CA (US); Sanish Mondkar, San Francisco, CA (US); Manish Jaiswal, Plano, TX (US); Varun Poddar, Bangalore (IN); Cat Bui, Garland, TX (US)

(72) Inventors: Yuan Tung, Fremont, CA (US); Sanish Mondkar, San Francisco, CA (US); Manish Jaiswal, Plano, TX (US); Varun Poddar, Bangalore (IN); Cat Bui, Garland, TX (US)

(73) Assignee: ARIBA, INC., Sunnyvale, CA (US)

(21) Appl. No.: 14/064,118

(22) Filed: Oct. 26, 2013

Related U.S. Application Data
(63) Continuation-in-part of application No. 13/249,876, filed on Sep. 30, 2011, now Pat. No. 8,612,300.
Application No. 13/249,876 is a continuation-in-part of application No. 11/517,944, filed on Sep. 8, 2006, now Pat. No. 8,190,482.

(51) Int. Cl. G06Q 30/06

(52) U.S. Cl. CPC G06Q 30/0605
USPC 705/26.2

(57) ABSTRACT

Embodiments of methods, systems and apparatus for integrating commerce networks are disclosed. One method includes receiving a commercial transaction request associated with a business process from a member of the second commerce network, to conduct commerce with a member of the first commerce network, wherein the request includes a second commerce network associated identifier, confirming that the member of the second commerce network is a user of the second commerce network based on the second commerce network associated identifier, enabling the member of the second commerce network to join the first commerce network upon confirmation that the member of the second commerce network is a user of the second commerce network, and allowing the member of the second commerce network to conduct commerce on the first commerce network after enabling the member of the second commerce network.

### RELATED APPLICATIONS

This patent application is a continuation-in-part (CIP) of U.S. patent application Ser. No. 13/249,876, filed Sep. 30, 2011, which is a continuation-in-part (CIP) of U.S. patent application Ser. No. 11/517,944, filed Sep. 8, 2006, and granted as U.S. Pat. No. 8,190,482 on May 29, 2012, which are all herein incorporated by reference.

### FIELD OF THE DESCRIBED EMBODIMENTS

The described embodiments relate generally to supplier/buyer commerce networks. More particularly, the described embodiments relate to a methods, apparatuses and systems for integration of multiple supplier/buyer commerce networks.

### BACKGROUND

Some supplier networks include a transaction routing hub that connects one or more suppliers and one or more buyers. As an example of how a supplier network is used, in some cases a given buyer enters or provides purchase information electronically and the purchase information is routed or otherwise sent to a given supplier. This may, for example, enable a buyer to make purchases in a completely paperless manner. Getting suppliers to join a supply network (that is, supplier enablement) is a necessary task but is often very time consuming. Improved techniques for supplier enablement are desirable.

Integration and enablement of multiple commerce networks is additionally complex. That is, the interactions of multiple users of multiple commerce networks can be cumbersome and the supplier enablement can be even more difficult than for a single commerce network.

Therefore, there is a need for systems, methods and apparatuses for providing integration and means for integration of multiple commerce networks.

### SUMMARY

An embodiment includes a computer-implemented method for integrating commerce networks. The method includes electronically interfacing a first commerce network with a second commerce network. The method further includes receiving, by the first commerce network, a commercial transaction request associated with a business process from a member of the second commerce network, to conduct commerce with a member of the first commerce network, wherein the request includes a second commerce network associated identifier, confirming, by the first commerce network, that the member of the second commerce network is a user of the second commerce network based on the second commerce network associated identifier, enabling, by the first commerce network, the member of the second commerce network to join the first commerce network upon confirmation that the member of the second commerce network is a user of the second commerce network, and allowing the member of the second commerce network to conduct commerce on the first commerce network after enabling the member of the second commerce network.

Another embodiment includes a computer-implemented method for integrating commerce networks. The method includes electronically interfacing a first commerce network with a second commerce network. The method further includes receiving, by the first commerce network, a request from a member of the first commerce network, to conduct commerce with a member of the second commerce network, confirming, by the first commerce network, that the member of the second commerce network is a user of the second commerce network based on a commerce network associates identifier of the member of the second commerce network, enabling, by the first commerce network, the member of the second commerce network upon confirmation that the member of the second commerce network is a user of the second commerce network, and allowing the member of the second commerce network to conduct commerce on the first commerce network in the future without requiring confirmation with the second commerce network that the member of the second commerce network is an enabled user.

Another embodiment includes a system for integrating commerce networks. The system includes a first commerce server of a first commerce network electronically interfaced with a second commerce server of a second commerce network. Further, the first commerce server is operative to receive a commercial transaction request associated with a business process from a member of the second commerce network, to conduct commerce with a member of the first commerce network, wherein the request includes a second commerce network associated identifier, confirm that the member of the second commerce network is a user of the second commerce network based on the second commerce network associated identifier, enable the member of the second commerce network to join the first commerce network upon confirmation that the member of the second commerce network is a user of the second commerce network, and allow the member of the second commerce network to conduct commerce on the first commerce network after enabling the member of the second commerce network.

Another embodiment includes a non-transitory program storage device readable by a machine, tangibly embodying a program of instructions executable by the machine to perform a computer-implemented method for integrating commerce networks. When executed, the computer-method performs the following steps: Receive a commercial transaction request associated with a business process from a member of the second commerce network, to conduct commerce with a member of the first commerce network, wherein the request includes a second commerce network associated identifier, confirm that the member of the second commerce network is a user of the second commerce network based on the second commerce network associated identifier, enable the member of the second commerce network to join the first commerce network upon confirmation that the member of the second commerce network is a user of the second commerce network, and allow the member of the second commerce network to conduct commerce on the first commerce network after enabling the member of the second commerce network.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows multiple commerce networks (including a parent network and children networks) that are integrated, and that facilitate enablement of buyers and suppliers, according to an embodiment.

FIG. 2 shows multiple commerce networks (including a peer networks) that are integrated, and that facilitate enablement of buyers and suppliers, according to another embodiment.

FIG. 3 is a diagram that illustrates an example of a method a commerce network electronically maintaining an account for a member of the commerce network, including a profile of a buyer or a supplier, according to another embodiment.

FIG. 4 is a flow chart that includes steps of a computer-implemented method for integrating commerce networks, according to an embodiment.

FIG. 5 is a flow chart that includes steps of another computer-implemented method for integrating commerce networks, according to an embodiment.

FIG. 6 shows a schematic illustration of one embodiment of a computer system that can perform the methods of the described embodiment, and/or can function as, for example, a supplier/buyer commerce network that facilitates a supplier/buyer commerce network in electronically enabling suppliers.

### DETAILED DESCRIPTION

The embodiments described include methods, systems and apparatuses for integration of multiple types of supplier/buyer commerce networks. Further, at least some embodiments include integration of the multiple supplier/buyer commerce networks that provides quick enablement of a supplier. An embodiment includes a supplier of one supplier/buyer commerce network being enabled with a single “one click” of the buyer of another supplier/buyer commerce network.

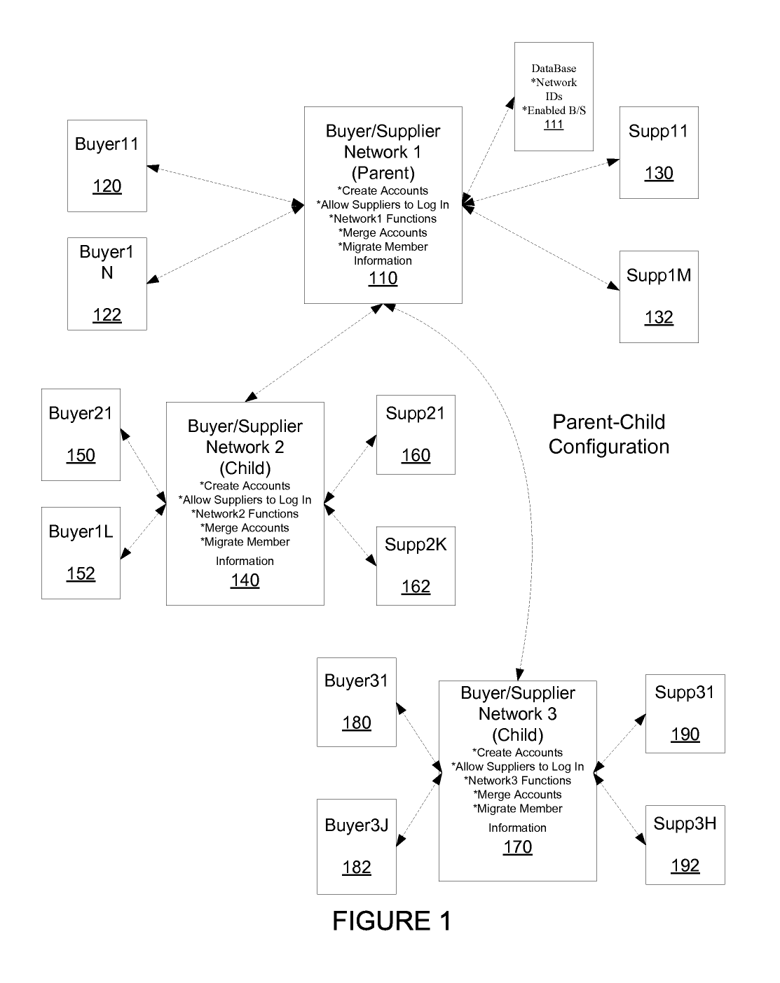

FIG. 1 shows multiple commerce networks (including a parent commerce network 110 and children commerce networks 140, 170) that are integrated, and that facilitate enablement of buyers and suppliers, according to an embodiment. For at least some embodiments, the parent commerce network 110 manages the interactions between members of the parent commerce network 110 and members of child commerce networks 140, 170. For at least some embodiments, the parent commerce network 110 manages interactions between members of the child commerce networks 140, 170.

For at least some embodiments, the members of each of the commerce networks 110, 140, 170 include buyers and sellers. While generally referred to as buyers and sellers, it is to be understood that for at least some embodiments the buyers and sellers includes servers and/or networks of the buyers and sellers or associated with the buyers and sellers, that are networked connected to the commerce networks 110, 140, 170. Furthers, sellers may alternatively be referred to as suppliers. As shown, the first (parent) commerce network 110 includes N buyers 120, 122 and M suppliers 130, 132, the second (child) network 140 includes L buyers 150, 152 and K suppliers 160, 162, and the third (child) network 170 includes J buyers 180, 182 and H suppliers 190, 192.

As shown, the first commerce network 110 is electronically interfaced with the second commerce network 140 and the third commerce network 170. While three commerce networks are show, it is to be understood that any number of commerce networks can be electronically connected. The electronic connections can be implemented using any type of networking technology, and can be facilitated by the internet.

For an embodiment, the first commerce network 110, the second commerce network 140 and the third commerce network 170 are initially independently operating commerce networks. At some point, the separate commerce networks 110, 140, 170 are integrated. Once integrated, the members (buyers and suppliers) of one of the commerce networks are able to interact with members (buyers and suppliers) of another one of the commerce networks. Such integration can occur, for example, if an owner of a first commerce networks buys another one of the commerce networks. The owner of the first commerce network can advantageously add the members of the acquired commerce network to the first commerce network, and advantageously add functionality provided by the acquired commerce network. The addition of members and functionality makes the combination of commerce networks stronger than the individual networks.

For an embodiment, the first commerce network 110 (once integrated with the second commerce network 140), receives a commercial transaction request associated with a business process from a member of the second commerce network, to conduct commerce with a member of the first commerce network, wherein the request includes a second commerce network associated identifier. For an embodiment, the business process includes collaborative procurement processes and/or request for quotes across suppliers in all integrated networks. Buyers submit requests for quote for products and suppliers across the multiple networks can respond and ask questions on the request for quote. For an embodiment, the commercial transaction request includes regional/country specific legal invoicing processes. For example, a Brazilian network can provide Brazilian specific invoicing process requirements for legal invoicing for members of other networks of other countries.

Once the first commerce network 110 is integrated with the second commerce network 140, the member of the second commerce network 140 can transact business with the member of the first commerce network 110. An embodiment includes the first commerce network confirming that the member of the second commerce network 140 is a user of the second commerce network 140 based on the second commerce network associated identifier. That is, the commercial transaction request of the member of the second commerce network includes the second commerce network associated identifier. For an embodiment, the first commerce network 110 maintains a database 111 that includes network IDs (identification or identifiers). The first commerce network 110 confirms that the member submitting the commercial transaction request is a member of the second commerce network by confirming the commerce network associated identifier of the commercial transaction request.

As an example, for an embodiment buyers of first commerce network 110 enters a supplier identifier of a vendor of the second commerce network 140 into a procurement application operating on the first commerce network 110. When a purchase order is transmitted by the second commerce network 140 to the first commerce network 110 for a buyer procurement application, the first commerce network 110 is automatically notified of the creation of the supplier from second commerce network 140.

If the commercial transaction request of the member of the second commerce network 140 is the first interaction of the member with the first commerce network 110, for an embodiment, the first commerce network 110 initiates enablement of the member of the second commerce network 140, so that future transactions with the member of the second commerce network 140 are more efficient. That is, in the future, the member of the second commerce network 140 is an enabled member of the first commerce network as well, and can than interact directly with the first commerce network 110 rather than interacting with the first commerce network 110 through the second commerce network 140.

For an embodiment, once the first commerce network 110 has confirmed that the member of the second commerce network 140 is a user of the second commerce network 140 based on the second commerce network associated identifier, the first commerce network 110 enables the member of the second commerce network 140 to join the first commerce network 110.

Enablement

For an embodiment, enabling the member (buyer or supplier) of the second commerce network 140 includes inviting the buyer or supplier of the second commerce network 140 to join the first commerce network 110. For an embodiment, enabling the member of the second commerce network 140 includes creating an account on the first commerce network 110, and populating the account with information related to the member of the second commerce network 140.

For at least some embodiments, enabling by the first commerce network 110 of a supplier of the second commerce network 140 includes the first commerce network 110 querying the second commerce network 140 using the supplier identifier to obtain a supplier profile of the supplier from the second commerce network.

An embodiment includes a supplier/buyer commerce network (for example, the first commerce network 110) receiving a commercial transaction associated with a business process between a supplier and a buyer, wherein the commercial transaction includes a purchase order for the supplier; determining, using a processor, that the supplier is not a member of a supplier/buyer network; and in response to the determination, initiating a supplier enablement action, wherein the supplier enablement action is associated with enabling the supplier to join the supplier network. Further, for an embodiment, the supplier/buyer commerce network (such as, the first commerce network) includes an interface configured to receive a commercial transaction associated with a business process between a supplier and a buyer, wherein the commercial transaction includes a purchase order for the supplier; and a processor configured to: determine that the supplier is not a member of a supplier network; and initiate a supplier enablement action in response to the determination, wherein the supplier enablement action is associated with enabling the supplier to join the supplier network.

For an embodiment, after enabling the member of the second commerce network 140 on the first commerce network 110, the first commerce network 110 then allows the member of the second commerce network to conduct commerce on the first commerce network 110. At least some embodiments include allowing the enabled member of the second commerce network to conduct future commerce on the first commerce network without confirming that the member of the second commerce network is a user of the second commerce network.

Migration

Once the member of the second commerce network 140 had been enabled, at least some embodiments include migrating account information of the member of the second commerce network 140 from the second commerce network 140 to the created account of the first commerce network 140. That is, for example, the second commerce network 140 has one or more databases in which member information is stored. After enabling the member of the second commerce network 140, the member information is migrated to one or more databases (such as database 111) of the first commerce network 110.

For an embodiment, the account information includes a member profile, wherein the member profile comprises aggregated activity information of the member of the second commerce network. As will be described, embodiments of the member profile further include self-reported information, community information, and/or third party information.

Business Functions

At least some embodiments further include allowing the member of the second commerce network to utilize business functions on the first commerce network after enabling the member of the second commerce network. For example, for an embodiment, the first commerce network supports legal invoicing functions of a first country and the second commerce network supports legal invoicing of a second country. Further, a buyer or supplier of the second commerce network is able to utilize the legal invoicing functions of the first country supported by the first commerce network, and a buyer or supplier of the first commerce network is able to utilize the legal invoicing functions of the second country supported by the second commerce network. As a result, the members of each of the commerce networks are able to benefit from the business functions provided by the other commerce networks that the commerce network has been integrated with.

The number of different possible business functions available to the enabled member of the commerce networks is not limited. For example, one commerce network may provide financial services like supplier chain financing which can be offered to the users of the other one of the commerce networks. Further requests for quotes can be across commerce networks. Using the supplier profiles from all commerce networks (that is, the first commerce network 110, the second commerce network 140, and the third commerce network 170) and matching criteria specified by the request for quotes across multiple networks, the right suppliers can be located who can best fulfill the requests for quotes. That is, the information base (supplier and buyer profiles) over the multiple commerce networks, and the sending of requests for quotes over the multiple networks provides a much stronger possibility of matching buyers with suppliers than each of the commerce networks operating individually.

Merging of Accounts

With the large number of buyer and supplier combinations possible with the integration of multiple commerce networks, it is possible to generate multiple accounts for a single buyer or supplier, which can lead to inefficiencies. For at least some embodiments, after enabling the buyer or supplier of the second commerce network, the first commerce network 110 presents one or more possible accounts; and receiving from the buyer or supplier of the second commerce network zero or more selections from the possible duplicate accounts.

For at least some embodiments, after enabling the buyer or supplier of the second commerce network, the commerce network (parent commerce network or peer commerce network) searches through a group of one or more accounts for one or more possible duplicate accounts. For an embodiment, the possible duplicate accounts are presented to the buyer or supplier of the second commerce network. An embodiment includes receiving from the buyer or supplier of the second commerce network zero or more selections from the possible duplicate supplier accounts. The duplicate accounts can then be merged.

For at least some embodiments, after presenting to the supplier or buyer of the first commerce network one or more possible duplicate supplier accounts, confidential information associated with the possible duplicate supplier account(s) is not made available to the supplier of the second commerce network. Zero or more selections are received from the supplier of the second commerce from the possible duplicate supplier accounts. The duplicate accounts can then be merged.

As shown in FIG. 1, for an embodiment, the first commerce network 110 is also electronically interfaced with the third commerce network 170. Further, similar to as described above for the second commerce network 140, for an embodiment, the first commerce network 110 receives a commercial transaction request associated with a business process from a member of the third commerce network 170, to conduct commerce with a member of the first commerce network 110, wherein the request includes a commerce network associates identifier. The first commerce network 110 confirms that the member of the third commerce network 170 is a user (for an embodiment, being a user means the member is an enabled user) of the third commerce network 170 based on the commerce network associated identifier. The first commerce network 170 then enables the member of the third commerce network 170 to join the first commerce network 110 upon confirmation that the member of the third commerce network 140 is a user of the third commerce network. The first commerce network 110 then allows the member of the third commerce network 170 to conduct commerce on the first commerce network 110 after enabling the member of the third commerce network 170.

For at least some embodiments, members of the second commerce network 140 are able to conduct business transactions with members of the first commerce network 110 or with the members of the third commerce network 170, with the first commerce network 110 managing the transactions. That is, the enablement processes and other functionality of the described embodiments are managed at the first commerce network 110.

As an example of how a purchase order is processed, suppose buyer 21 150 wants to make a purchase from supplier 11 130. A purchase order or some purchase related information is sent to the first commerce network 110 from buyer 21 150 through the second commerce network 140. In some embodiments, the purchase order or other business process related information is sent to the first commerce network 110 through the second commerce network 140 electronically. For example, in some embodiments, a user at buyer 21 150 goes to a particular website or starts an application and enters purchase or other business process information. A variety of information may be provided, such as a supplier ID, a requested good/service, a quantity, a delivery date, a delivery location, a contact person or person associated with the buyer, etc.

There are a number of conveniences or advantages for a supplier and/or buyer that participate in the integrated commerce networks. In some cases, a particular buyer is a large enterprise or corporation with thousands or tens of thousands of suppliers and/or a similar number of employees who can make purchases. Since all of the purchase or other business process information is stored electronically, processing and/or manipulation of purchase related information can be performed if so desired. In some embodiments, the integrated commerce networks are associated with a variety of reporting, auditing, and/or forecasting functions since data is stored electronically. Another advantage is the elimination of paper purchase orders on the buyer side. For example, the costs of materials associated with printer ink, paper, or stamps may be reduced or eliminated. In some cases, other resources such as manpower or paper records/repositories associated with purchase orders are similarly eliminated or conserved.

The integrated commerce networks similarly offer some advantages for participating suppliers. For at least some embodiments, the integrated commerce networks enables a single communication channel via which purchase orders from many buyers are received. For example, without the integrated commerce networks, one buyer may send their purchase orders via fax while another sends purchase orders via the post office. It may be inconvenient to check multiple channels of communication. In some cases, the format of purchase orders varies from buyer to buyer. One buyer may use one purchase order form with one set of fields and another uses another form. In some cases, a supplier who participates in the integrated commerce networks is a preferred or otherwise desirable supplier. For example, some buyers have business practices or policies in place to only (or when possible) make purchases from suppliers in the integrated commerce networks. Not participating in the integrated commerce networks may mean a loss of business from buyers that have such policies or preferences.

However, before such benefits can be realized, supplier enablement (i.e., getting a supplier to join one of the integrated commerce networks) must be performed. In various embodiments, supplier enablement includes creation of a supplier account on the parent commerce network, or a peer commerce network (in some embodiments, this is not initiated by or performed by the supplier), populating or otherwise filling in the supplier account with information about the supplier, taking ownership of such an account, and/or committing or agreeing to any stipulated fees, terms, or conditions.

In many cases, supplier enablement is a difficult and/or time consuming task. Invite based supplier enablement and bulk ramp supplier enablement are two techniques for supplier enablement. In some systems, a buyer invites suppliers to join a supplier network, for example by having an employee of the buyer provide or enter information about its buyers via a website. A supplier receives an invitation and goes to a transaction routing hub or associated device and creates a supplier account, thus joining the supplier network.

In the examples shown and described, supplier enablement is performed in an organic manner. In some embodiments, organic supplier enablement means that some or all of a supplier enablement process is performed in response to a business transaction associated with a purchase or other business process. In this example, the business transaction is a purchase order. In some embodiments, some other event or business transaction besides a purchase order is used to initiate a task or process associated with supplier enablement and/or to determine which supplier such a task or process is performed for. In some embodiments, some other business process besides a purchase is used. For example, some systems are configured to use a Request for Information (RFI) and/or a Request for Proposal (RFQ).

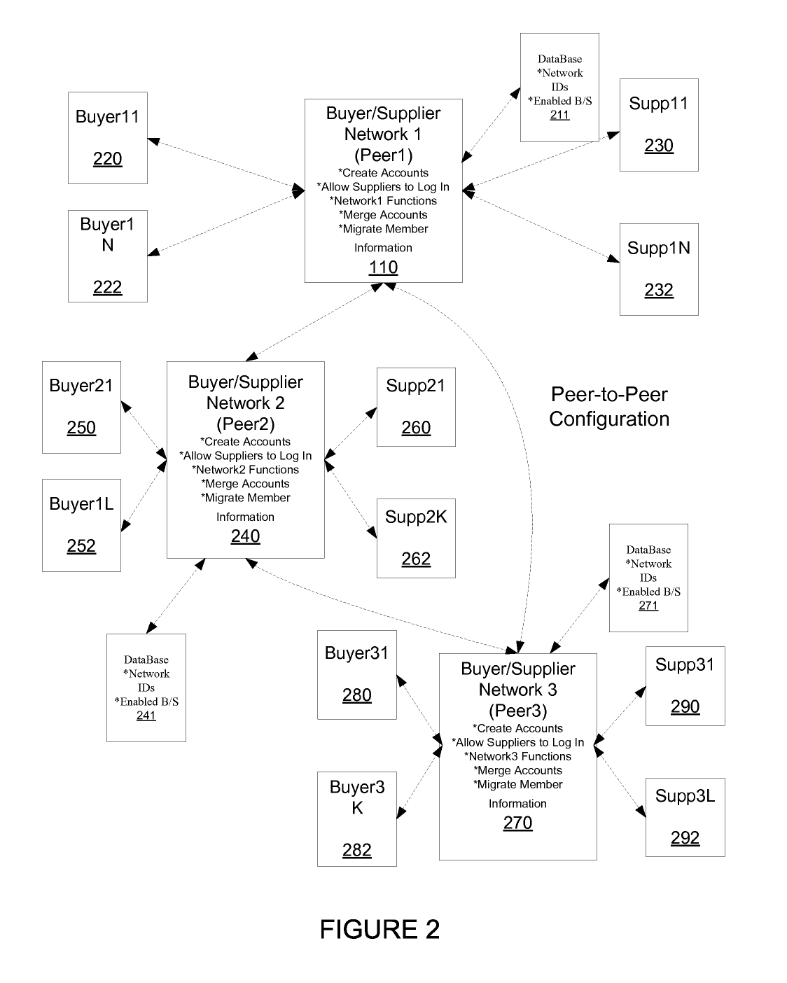

FIG. 2 shows multiple commerce networks (including a peer networks) that are integrated, and that facilitate enablement of buyers and suppliers, according to another embodiment. Here, rather than the parent-child relationship of FIG. 1 in which the first commerce network 110 manages the described embodiments, the first commerce network 210, the second commerce network 240 and the third commerce network 270 can each managed the describe embodiments for enablement, utilization of business functions, migration of member account information and merging of duplicate accounts.

For at least some embodiments, the members of each of the commerce networks 210, 240, 270 include buyers and sellers (generically described as members). While generally referred to as buyers and sellers, it is to be understood that for at least some embodiments the buyers and sellers includes servers and/or networks of the buyers and sellers. Furthers, sellers may alternatively be referred to as suppliers. As shown, the first (peer1) commerce network 210 includes N buyers 220, 222 and M suppliers 230, 232, the second (peer2) network 240 includes L buyers 250, 252 and K suppliers 260, 262, and the third (peer3) network 270 includes J buyers 280, 282 and H suppliers 290, 292.

As each of the commerce networks 210, 240, 270 can perform the described embodiments for integrating the operations of the commerce networks 210, 240, 270, each of the commerce networks 210, 240, 270 maintain a database 211, 241, 271 that includes the network IDs of each of the other integrated networks, thereby allowing each of the commerce networks 210, 240, 270 to perform the operation of confirming that the member of the another commerce network 140 is a user of that other commerce network 140 based on the commerce network associated identifier. For an embodiment, the commerce networks 210, 240, 270 maintain the databases 211, 241, 271 that include the network IDs (identification or identifiers). Each commerce network 210, 240, 270 confirms that the member submitting the commercial transaction request is a member of the other commerce network by confirming the commerce network associated identifier of the commercial transaction request.

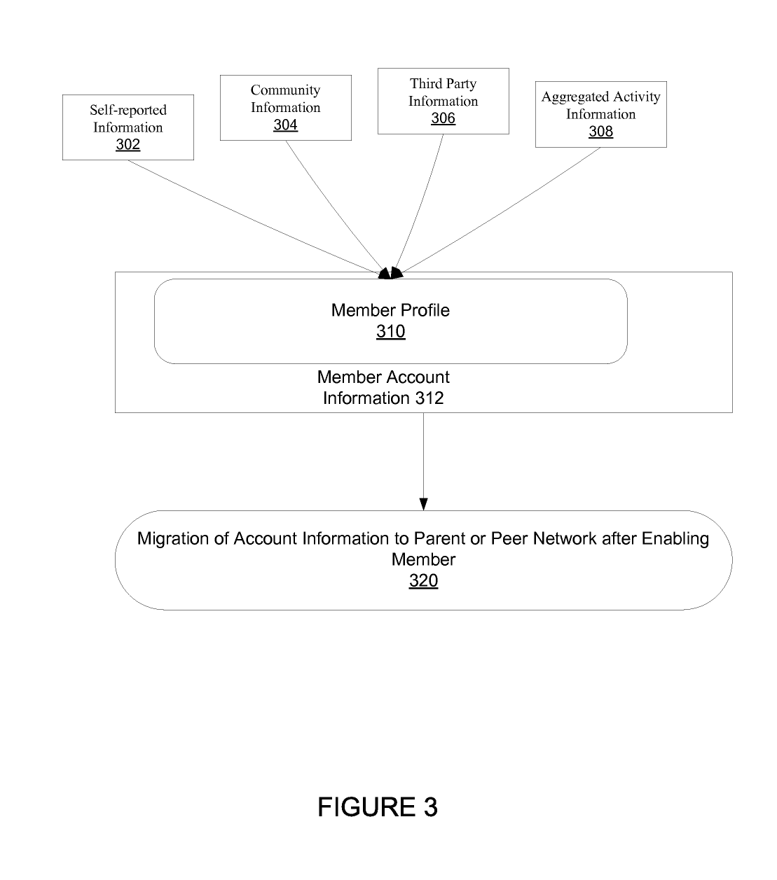

FIG. 3 is a diagram that illustrates a functional diagram of a commerce network electronically maintaining an account for a member of the commerce network, including a profile of a buyer or a supplier, according to another embodiment. The account includes member account information 312 which for at least some embodiments includes a member (buyer or supplier) profile 310.

As previously described, when a member of a second commerce network has been enabled by a first commerce network, for at least some embodiments, the first commerce network migrates 320 the member account information 312 of the second commerce network to the first commerce network.

The member account information 312 can include any information about the member. For an embodiment, the member profile 310 includes at least one of self-reported information 302, community information 304, third party information 306 and/or aggregated activity information 308.

As shown, and previously described, an embodiment of the member profile 310 includes four quadrants, wherein a first quadrant (A) includes self-reported information 302, a second quadrant (B) includes community information 304, a third quadrant (C) includes third party information 304, and fourth quadrant (D) includes aggregated activity information 308. It is to be understood that for some embodiments the member profile 310 can include a subset of these quadrants, and for other embodiments, the member profile 310 can include information in addition to the information of these four quadrants. The member profile 310 is a collection of information pertaining to the corresponding member that is associated with the commerce network. The member profile allows other companies (suppliers and/or buyers) to evaluate the company associated with the member profile 310. Clearly, the company profile can include fewer or more than the four quadrants.

The self-reported information (quadrant A) can be from (suppliers and/or buyers) includes company provided information that can be received by the commerce network and incorporated into the member profile. The self-reported information can be received in different ways. For example, a member (buyer or supplier company) may effectively “walk up” and join the commerce network, or the company information can be loaded by the commerce network or from another database or application. For an embodiment, the public information becomes a part of the member profile.

For embodiments, pieces of the self-reported information are used to drive additional processes in the commerce network. That is, for example the self-reported information can include a DUNS number field. Once the commerce network has the DUNS number, the commerce network can provide financial risk score information on the member (buyer or supplier). The DUNS number can be used to drive communication with, for example, a third party.

The community information (quadrant B) includes information that pertains to the member that is provided, for example, by suppliers and buyers associated with the commerce network. The community information includes, for example, ratings. The ratings allow, for example, a buyer to rate any supplier that has responded to a business opportunity on the commerce network.

Another aspect of the community information includes references. For at least some embodiments, a reference is a quote/citation from a buyer/customer which represents or verifies the quality performance of the good or service being supplied by the supplier/seller. For at least some embodiments, references include contact information for the buyer/customer such that other buyers who are interested in the supplier for whom the reference was given. The contact information is offered for other buyers to reach out to the buyer giving a reference for additional communications/elaboration about the seller/suppliers performance. To further facilitate community and parallel real world interactions, embodiments of the supplier/buyer commerce network allows other buyers to request contact with the author of any given reference. For embodiments, the subject of the reference (the supplier) is the gatekeeper in such an interaction and may decline or accept the third party's request to speak with a reference. For embodiments, the reference itself contains a few pieces of information, for example, a text narrative, industry of the buyer, and/or length of the business relationship.

The third party information (quadrant C) includes information that pertains to the company that is provided by a third party who is typically not associated directly with the commerce network. The third party information includes, for example, a business and credit rating provided by, for example, an established rating agency (such as, Dun & Bradstreet® (D&B)). The third party information can include financial risk information about suppliers. This can be linked or associated with the suppliers using self-reported DUNS number information. The DUNS information can be validated with D&B using an API call. The validated information can be displayed back to the supplier for their approval. Once approved, the supplier/buyer commerce network basically has the supplier linked to a risk profile on D&B.

The aggregated activity information includes, for example, transactional activity of the member (buyer or supplier). For example, the aggregated activity information can include information about suppliers and their performance on the commerce network.

A useful piece of aggregated activity information included within the company profile is the number of transacting relationships that the company has with buyers/suppliers on the commerce network, and/or transacting relationships the company has with buyers/suppliers of other commerce networks (that is, commerce networks other than the integrated commerce networks), such as cloud networks. This information provides a valuable picture of how many other companies the company is actively doing business with via the commerce network, and the cloud networks. It is to be understood that doing business with other companies includes activities and can include interactions that do not include money, good or services changing hands. If the supplier/buyer commerce network is interfaced with cloud networks, the member profile can be made to be common (the same) between commerce network platforms. Therefore, real-time information can be utilized across the commerce and cloud network networks.

Examples of aggregated activity information include, but are not limited to, event invitations, invitations by revenue, transaction awards (for example, winning supplier bids), revenue ranges, and/or top bids by industry.

The interface between the commerce network and cloud networks allows the commerce network to glean additional information that can be useful for enhancing the value of the company profile. For example, cloud network can include sourcing and/or contract information and data. These embodiments determine commonality of suppliers/buyers across multiple private cloud networks. For at least some embodiments, one or more databases are associated with networks that maintain transactional activity of the company with other companies, and this transaction information for the company is identified by the unique identifier of the company.

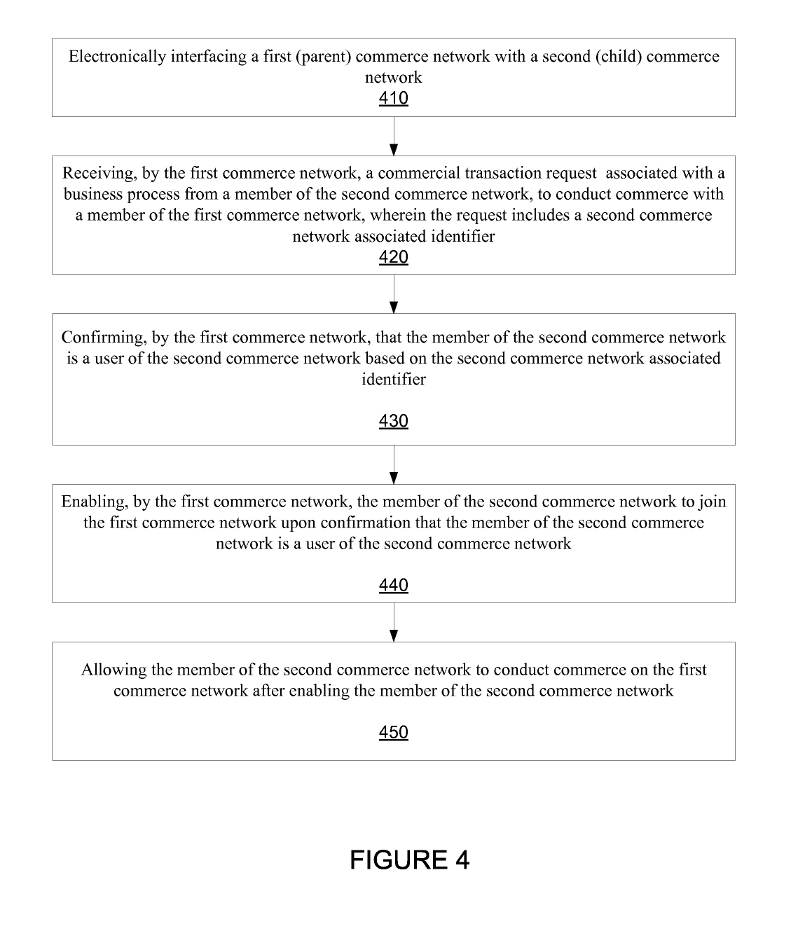

FIG. 4 is a flow chart that includes steps of a computer-implemented method for integrating commerce networks, according to an embodiment. A first step 410 includes electronically interfacing a first commerce network with a second commerce network. A second step 420 includes receiving, by the first commerce network, a commercial transaction request associated with a business process from a member of the second commerce network, to conduct commerce with a member of the first commerce network, wherein the request includes a second commerce network associated identifier. A third step 430 includes confirming, by the first commerce network, that the member of the second commerce network is a user of the second commerce network based on the second commerce network associated identifier. A fourth step 440 includes enabling, by the first commerce network, the member of the second commerce network to join the first commerce network upon confirmation that the member of the second commerce network is a user of the second commerce network. A fifth step 450 includes allowing the member of the second commerce network to conduct commerce on the first commerce network after enabling the member of the second commerce network.

In some embodiments, business transaction information or other confidential or proprietary information is kept in confidence. For example, the terms of a purchase between a particular buyer and supplier may be kept confidential from other buyers/suppliers not involved in the purchase.

As previously described, an embodiment further includes allowing the enabled member of the second commerce network to conduct future commerce on the first commerce network without confirming that the member of the second commerce network is a user of the second commerce network. As previously described, an embodiment further includes enabling the member of the second commerce network comprises creating an account on the first commerce network, and populating the account with information related to the member of the second commerce network. For an embodiment, enabling the member of the second commerce network includes inviting the member of the second commerce network to join the first commerce network.

As previously described, an embodiment further includes migrating account information of the member of the second commerce network from the second commerce network to the created account of the first commerce network. For at least some embodiments, the account information comprises a member profile, wherein the member profile comprises aggregated activity information of the member of the second commerce network. At least some embodiments further include allowing the member of the second commerce network to utilize business functions on the first commerce network after enabling the member of the second commerce network. For example, for an embodiment, the first commerce network supports legal invoicing functions of a first country and the second commerce network supports legal invoicing of a second country, and the buyer of supplier of the second commerce network is able to utilize the legal invoicing functions of the first country supported by the first commerce network.

As previously described, an embodiment further includes after enabling the member of the second commerce network, presenting one or more possible accounts; and receiving from the member of the second commerce network zero or more selections from the possible duplicate accounts.

As previously described, an embodiment further includes after enabling the member of the second commerce network, searching through a group of one or more accounts for one or more possible duplicate accounts to be presented, wherein for each account in the group a corresponding member has taken ownership for that account; presenting to the member of the second commerce network the possible duplicate supplier accounts; and receiving from the member of the second commerce network zero or more selections from the possible duplicate supplier accounts.

An embodiment includes identifying that at least one of the member of the first network or the member of the second network is a buyer that is attempting to purchase a complex product or service based on tracking behavior of the member of the first network or the member of the second network. In certain situations, a buyer can be purchasing a good or service that is complex enough that the buyer ideally receives some instructive information from informed suppliers. The embodiments described provide a commerce network that can determine when a buyer is purchasing a complex good or service, and intelligently connect the buyer with a set of suppliers that have information about the good or service that can simplify the purchasing process for the buyer. Further, an approved set of suppliers can be enabled to allow the suppliers to conduct business with the buyer through the commerce network. For at least one embodiment, the approved list of suppliers is received from the buyer, and selected suppliers from the approved list are enabled and allowed to fulfill the buyer's need for the complex good or service. Enablement is completed by getting suppliers to join a supply network (that is, supplier enablement). The described embodiments simply and efficiently implement the enablement process for suppliers (quick enable) that are provided by the buyer.

An embodiment includes pushing descriptive information of the complex product or service to the buyer based on identifying that the identified buyer is attempting to purchase a complex product or service. An embodiment includes pushing a filtered list of approved suppliers to the buyer based on identifying the buyer is attempting to purchase a complex product or service.

For an embodiment, enabling the member of the second commerce network includes determining that the member of the second network is not a member of a first network; and in response to the determination, initiating a supplier enablement action, wherein the supplier enablement action is associated with enabling the member of the second network to join the first network.

As previously described, an embodiment further includes presenting to the supplier or buyer of the second commerce network one or more possible duplicate supplier accounts, wherein confidential information associated with the possible duplicate supplier account(s) is not made available to the supplier of the second commerce network; and receiving from the supplier of the second commerce network zero or more selections from the possible duplicate supplier account(s).

As previously described, an embodiment further includes electronically interfacing the first commerce network with a third commerce network, receiving, by the first commerce network, a commercial transaction request associated with a business process from a member of the third commerce network, to conduct commerce with a member of the first commerce network, wherein the request includes a commerce network associates identifier, confirming, by the first commerce network, that the member of the third commerce network is a user of the second commerce network based on the commerce network associates identifier, enabling, by the first commerce network, the member of the third commerce network to join the first commerce network upon confirmation that the member of the third commerce network is a user of the third commerce network, and allowing the member of the third commerce network to conduct commerce on the first commerce network after enabling the member of the third commerce network.

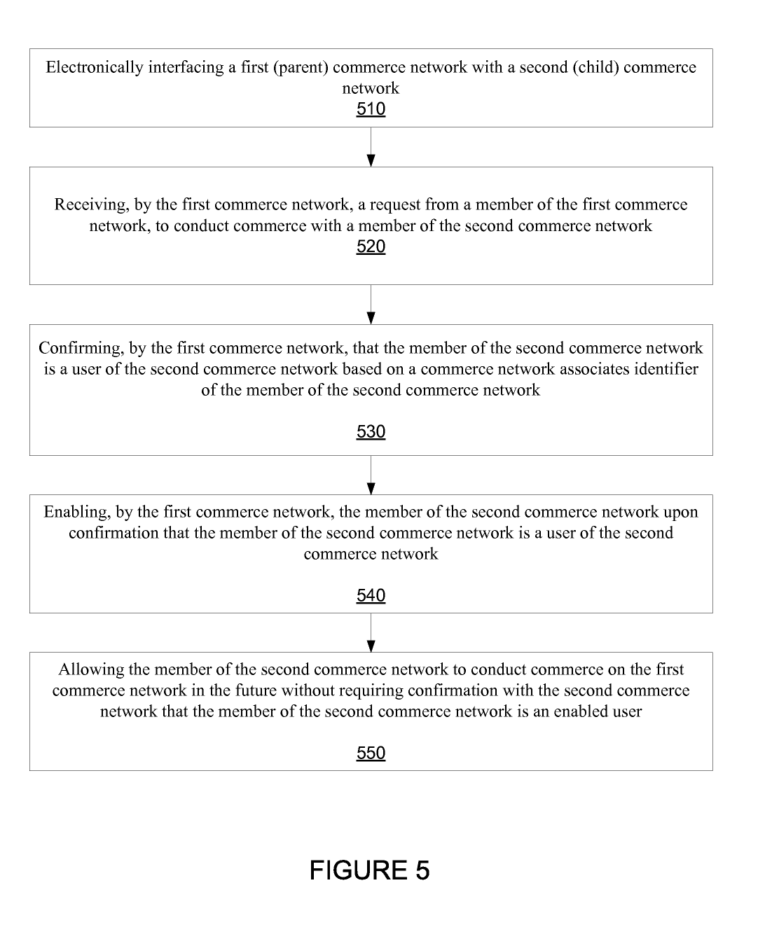

FIG. 5 is a flow chart that includes steps of another computer-implemented method for integrating commerce networks, according to an embodiment. A first step 510 includes electronically interfacing a first commerce network with a second commerce network. A second step 520 includes receiving, by the first commerce network, a request from a member of the first commerce network, to conduct commerce with a member of the second commerce network. A third step 530 includes confirming, by the first commerce network, that the member of the second commerce network is a user of the second commerce network based on a commerce network associates identifier of the member of the second commerce network. A fourth step 540 includes enabling, by the first commerce network, the member of the second commerce network upon confirmation that the member of the second commerce network is a user of the second commerce network. A fifth step 550 includes allowing the member of the second commerce network to conduct commerce on the first commerce network in the future without requiring confirmation with the second commerce network that the member of the second commerce network is an enabled user.

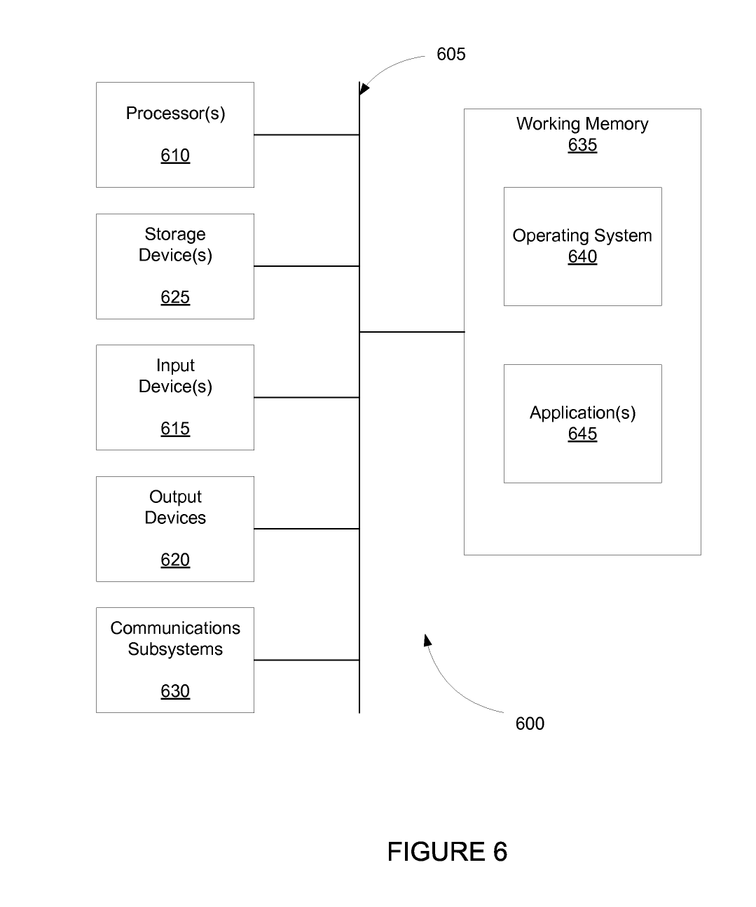

FIG. 6 shows a schematic illustration of one embodiment of a computer system that can perform the methods of the described embodiment, and/or can function as, for example, a buyer/supplier network that aids supplier enablement through creation of a requisition between a buyer and a supplier. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements can include one or more processors 610, communication subsystems 630, one or more input devices 615, which can include without limitation a mouse, a keyboard and/or the like; and one or more output devices 620, which can include without limitation a display device, a printer and/or the like. The computer system 600 may further include (and/or be in communication with) one or more storage devices 625. The computer system 600 also can comprise software elements, shown as being located within the working memory 635, including an operating system 640 and/or other code, such as one or more application programs 645, which may comprise computer programs of the described embodiments, and/or may be designed to implement methods of the described embodiments of a computer-implemented method for integrating commerce networks and/or configure systems of the embodiments as described herein.

At least some embodiments includes a non-transitory program storage device readable by a machine (of the supplier/buyer commerce network), tangibly embodying a program of instructions executable by the machine to perform a computer-implemented method for integrating commerce networks. When executed, the computer-method performs the following steps: Receive a commercial transaction request associated with a business process from a member of the second commerce network, to conduct commerce with a member of the first commerce network, wherein the request includes a second commerce network associated identifier, confirm that the member of the second commerce network is a user of the second commerce network based on the second commerce network associated identifier, enable the member of the second commerce network to join the first commerce network upon confirmation that the member of the second commerce network is a user of the second commerce network, and allow the member of the second commerce network to conduct commerce on the first commerce network after enabling the member of the second commerce network.

The described embodiments can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the described embodiments may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the described embodiments.

A detailed description of one or more embodiments of the described embodiments is provided above along with accompanying figures that illustrate the principles of the described embodiments. The described embodiments are described in connection with such embodiments, but the described embodiments are not limited to any embodiment. The scope of the described embodiments is limited only by the claims and the described embodiments encompass numerous alternatives, modifications and equivalents. Numerous specific details are set forth in the following description in order to provide a thorough understanding of the described embodiments. These details are provided for the purpose of example and the described embodiments may be practiced according to the claims without some or all of these specific details. For the purpose of clarity, technical material that is known in the technical fields related to the described embodiments has not been described in detail so that the described embodiments are not unnecessarily obscured.

Although specific embodiments have been described and illustrated, the embodiments are not to be limited to the specific forms or arrangements of parts so described and illustrated.

What is claimed:

1. A computer-implemented method for integrating commerce networks, comprising:
electronically interfacing a first commerce network with a second commerce network;
receiving, by the first commerce network, a commercial transaction request associated with a business process from a member of the second commerce network, to conduct commerce with a member of the first commerce network, wherein the request includes a second commerce network associated identifier;
confirming, by the first commerce network, that the member of the second commerce network is a user of the second commerce network based on the second commerce network associated identifier;
enabling, by the first commerce network, the member of the second commerce network to join the first commerce network upon confirmation that the member of the second commerce network is a user of the second commerce network; and
allowing the member of the second commerce network to conduct commerce on the first commerce network after enabling the member of the second commerce network.

2. The computer-implemented method of claim 1, further comprising allowing the enabled member of the second commerce network to conduct future commerce on the first commerce network without confirming that the member of the second commerce network is a user of the second commerce network.

3. The computer-implemented method of claim 1, wherein enabling the member of the second commerce network comprises creating an account on the first commerce network, and populating the account with information related to the member of the second commerce network.

4. The computer-implemented method of claim 3, further comprising migrating account information of the member of the second commerce network from the second commerce network to the created account of the first commerce network.

5. The computer-implemented method of claim 3, wherein the account information comprises a member profile, wherein the member profile comprises aggregated activity information of the member of the second commerce network.

6. The computer-implemented method of claim 1, further comprising allowing the member of the second commerce network to utilize business functions on the first commerce network after enabling the member of the second commerce network.

7. The computer-implemented method of claim 1, wherein the business process includes a purchase.

8. The computer-implemented method of claim 1, wherein the commercial transaction includes an invoice.

9. The computer-implemented method of claim 1, wherein enabling the member of the second commerce network includes inviting the member of the second commerce network to join the first commerce network.

10. The computer-implemented method of claim 1, further comprising:
identifying that at least one of the member of the first network or the member of the second network is a buyer that is attempting to purchase a complex product or service based on tracking behavior of the member of the first network or the member of the second network;
pushing descriptive information of the complex product or service to the buyer based on identifying that the identified buyer is attempting to purchase a complex product or service.
pushing a filtered list of approved suppliers to the buyer based on identifying the buyer is attempting to purchase a complex product or service.

11. The computer-implemented method of claim 1, wherein enabling the member of the second commerce network includes determining that the member of the second network is not a member of a first network; and in response to the determination, initiating a supplier enablement action, wherein the supplier enablement action is associated with enabling the member of the second network to join the first network.

12. The computer-implemented method of claim 1, further comprising, after enabling the member of the second commerce network, presenting one or more possible accounts; and receiving from the member of the second commerce network zero or more selections from the possible duplicate accounts.

13. The computer-implemented method of claim 1, further comprising, after enabling the member of the second commerce network, searching through a group of one or more accounts for one or more possible duplicate accounts to be presented, wherein for each account in the group a corresponding member has taken ownership for that account; presenting to the member of the second commerce network the possible duplicate supplier accounts; and receiving from the member of the second commerce network zero or more selections from the possible duplicate supplier accounts.

15. The computer-implemented method of claim 1, further comprising presenting to the supplier or buyer of the first commerce network one or more possible duplicate supplier accounts, wherein confidential information associated with the possible duplicate supplier account(s) is not made available to the supplier of the second commerce network; and receiving from the supplier of the second commerce network zero or more selections from the possible duplicate supplier account(s).

14. The computer-implemented method of claim 1, further comprising:
electronically interfacing the first commerce network with a third commerce network;
receiving, by the first commerce network, a commercial transaction request associated with a business process from a member of the third commerce network, to conduct commerce with a member of the first commerce network, wherein the request includes a commerce network associates identifier;
confirming, by the first commerce network, that the member of the third commerce network is a user of the second commerce network based on the commerce network associates identifier;
enabling, by the first commerce network, the member of the third commerce network to join the first commerce network upon confirmation that the member of the third commerce network is a user of the third commerce network; and
allowing the member of the third commerce network to conduct commerce on the first commerce network after enabling the member of the third commerce network.

15. A computer-implemented method for integrating commerce networks, comprising:
electronically interfacing a first commerce network with a second commerce network;
receiving, by the first commerce network, a request from a member of the first commerce network, to conduct commerce with a member of the second commerce network;
confirming, by the first commerce network, that the member of the second commerce network is a user of the second commerce network based on a commerce network associates identifier of the member of the second commerce network;
enabling, by the first commerce network, the member of the second commerce network upon confirmation that the member of the second commerce network is a user of the second commerce network; and
allowing the member of the second commerce network to conduct commerce on the first commerce network in the future without requiring confirmation with the second commerce network that the member of the second commerce network is an enabled user.

16. A system for integrating commerce networks, comprising:
a first commerce server of a first commerce network electronically interfaced with a second commerce server of a second commerce network;
the first commerce server operative to:
receive a commercial transaction request associated with a business process from a member of the second commerce network, to conduct commerce with a member of the first commerce network, wherein the request includes a second commerce network associated identifier;
confirm that the member of the second commerce network is a user of the second commerce network based on the second commerce network associated identifier;
enable the member of the second commerce network to join the first commerce network upon confirmation that the member of the second commerce network is a user of the second commerce network; and
allow the member of the second commerce network to conduct commerce on the first commerce network after enabling the member of the second commerce network.

17. The system of claim 16, wherein the first commerce server is further operative to allowing the enabled member of the second commerce network to conduct future commerce on the first commerce network without confirming that the member of the second commerce network is a user of the second commerce network.

18. The system of claim 16, wherein enabling the member of the second commerce network comprises creating an account on the first commerce network, and populating the account with information related to the member of the second commerce network.

19. The system of claim 18, wherein the first commerce server is further operative to migrate account information of the member of the second commerce network from the second commerce network to the created account of the first commerce network.

20. The system of claim 18, wherein the account information comprises a member profile, wherein the member profile comprises aggregated activity information of the member of the second commerce network.

21. The system of claim 16, wherein the first commerce server is further operative to allow the member of the second commerce network to utilize business functions on the first commerce network after enabling the member of the second commerce network.

22. The system of claim 16, wherein the first commerce server is further operative to present one or more possible accounts; and receive from the member of the second commerce network zero or more selections from the possible duplicate accounts.
